(19) United States
(12) Patent Application Publication
(10) Pub. No.: US 2003/0034889 A1
(43) Pub. Date: Feb. 20, 2003

(54) Host system and method for sensed vehicle data

(76) Inventors: Craig S. Rendahl, Tucson, AZ (US); John DiDomenico, Tucson, AZ (US); Paul F. Kyle, Tucson, AZ (US); Adam W. Saxton, Tucson, AZ (US); Brett J. Morien, Tucson, AZ (US)

Correspondence Address: BAKER + HOSTETLER LLP, WASHINGTON SQUARE, SUITE 1100, 1050 CONNECTICUT AVE. N.W., WASHINGTON, DC, 20036-5304, US

(21) Appl. No.: 09/931,774

(22) Filed: Aug. 20, 2001

(51) Int. Cl. G08G 1/01

(52) U.S. Cl. 340/540; 340/933; 340/936; 340/937; 340/632

(57) ABSTRACT

A system for processing sensed vehicle data includes a sensor for sensing data related to at least one characteristic of a passing vehicle and a host unit that receives sensed data from the sensor. The sensor and the host unit are integrated into a single housing. The host stores data and communicates with peripheral devices and/or with a central processing facility.

### FIELD OF THE INVENTION

The present invention relates generally to systems and methods for processing information that is detected related to vehicles. More particularly, the present invention relates to systems and methods for handling data that is detected relative to vehicles, including, for example, sensed vehicle emission data, sensed vehicle speed data, and captured video information related to vehicles.

### BACKGROUND OF THE INVENTION

It is known in the art of vehicle emissions and traffic handling devices to have a system mounted along a vehicle path, such as a lane of a roadway, that can detect various characteristics of passing vehicles. For example, such a system may include a vehicle emissions sensing device that includes a projector/receiver element that projects a light beam across the vehicle path, has it reflected back by a mirror on the other side of the vehicle path, and receives the reflected beam and processes the reflected beam to determine information regarding the emissions from the vehicle.

It is also known to have a vehicle speed and acceleration detecting system on the side of the roadway. Further, it is known to have a video camera placed on the side of the roadway capable of capturing video images of the vehicles, for example, to determine the license plate of the vehicle.

In the exemplary known arrangement described above, each of the three systems: (1) emissions; (2) speed and acceleration; and (3) camera, have been known to be each connected by a respective cable to various processing units that are located in a van positioned on the side of the road near the systems. It is known for the van to have a variety of data processing and data collection devices so that it receives data from each of the three systems and processes it in various manners. The van generally has a method for recording data while at a data gathering site, and is then driven to a central data processing facility in order for the data to be more fully processed at the central data processing facility.

Thus, in the known exemplary system described above, the van operator generally drives to an emissions testing site with all of the equipment including the three detection systems loaded in the van, then unloads these systems and must align them as necessary. The operator then remains with the van while the systems are operating and controls the systems and monitors the data collection while in the van. At the end of a prescribed time (i.e., a sensing session) the operator then disassembles the various sensing equipments from the roadway, loads them into the van, and drives to the central processing facility.

The known arrangement utilizing the van as described above has several disadvantages. One disadvantage is that the external vehicle (i.e., the van) takes up a significant amount of space on the side of the road. Further, the systems generally requires an attendant at all times. Also, the cables used to connect the various devices to the van create clutter, are inconvenient, and susceptible to damage. Moreover, the security of the systems would be desirable if made stronger.

Accordingly, it is desirable to provide a system that reduces the size and mass of apparatus required for sensing and capturing vehicle data along the vehicle path such as a roadway. It is also desirable to have a convenient and secure device and method for processing sensed vehicle data and transmitting it to a central processing facility.

### SUMMARY OF THE INVENTION

It is therefore a feature and advantage of the present invention to provide a system that reduces the size and mass of apparatus required for sensing and capturing vehicle data along the vehicle path such as a roadway.

It is another feature and advantage of the present invention to provide a convenient and secure device and method for processing sensed vehicle data and transmitting it to a central processing facility.

The above and other features and advantages are achieved through the use of a novel host system and method for sensed vehicle data as herein disclosed. In accordance with one embodiment of the present invention, a system for processing sensed vehicle data includes a sensor for sensing data related to at least one characteristic of a passing vehicle and a host unit that receives sensed data from the sensor. The sensor and the host unit are integrated into a single housing. The host stores data and communicates with peripheral devices and/or with a central processing facility.

In accordance with another embodiment of the present invention, a method is provided for processing sensed vehicle data, comprising the steps of: sensing data related to at least one characteristic of a passing vehicle, receiving and storing the sensed data with a host unit that is integrated into a single housing together the sensor, and communicating between the host and a peripheral device. The peripheral device comprises at least one of a laptop computer, a Personal Digital Assistant, and a desktop computer.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic plan view illustrating several elements of a preferred embodiment of the present invention.

FIG. 2 is a schematic view depicting a host and various data input and output devices, and other devices which may be utilized in preferred embodiments of the invention.

FIG. 3 is a schematic view depicting several modes of communication that may utilized between a host and various other devices in preferred embodiments of the invention.

### DETAILED DESCRIPTION OF PREFERRED EMBODIMENTS OF THE INVENTION

The preferred embodiments of the present invention provides a system that reduces the size and mass of apparatus required for sensing and capturing vehicle data along the vehicle path such as a roadway. Also provided in preferred embodiments are a convenient and secure device and method for processing sensed vehicle data and transmitting it to a central processing facility.

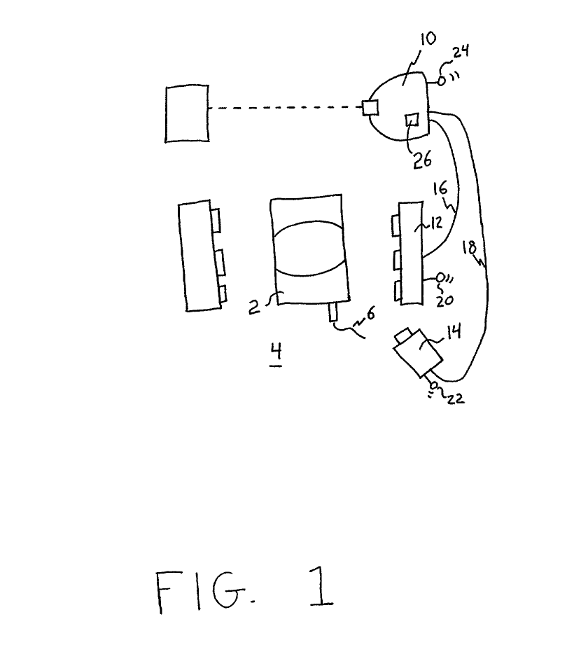

A preferred embodiment of the present inventive apparatus and method is illustrated in FIG. 1, which illustrates a vehicle 2 travelling along a path and producing an emissions plume 6. An integral host device 10 includes apparatus for projecting a beam across the vehicle path and receiving the reflected beam from a reflector across the path. When a vehicle has crossed the beam path, emissions from the tail pipe 6 can be detected by appropriate circuitry within the host unit 10.

Also provided with the system may be a speed and acceleration sensor 12 and a video or other type of camera 14. The speed and acceleration sensor 12 may detect data regarding the speed and/or acceleration of the vehicle as it passes, and the camera 14 may provide a picture of the vehicle including its license plate.

In one embodiment, the speed and acceleration sensor 12 and camera 14 may communicate with the host 10 via wires 16 and 18 respectively. Alternatively, either of both of these units may communicate wirelessly via an antenna 20 on the speed and acceleration sensor 12, and an antenna 22 on the camera 14, with an antenna 24 provided on the host unit 10. Thus, either or both of the devices 12 and 14 may communicate by either a corded or wireless fashion with the host unit 10.

The host unit 10 receives data regarding each passing vehicle, which may include in the preferred embodiment speed and acceleration data, video or other picture data of the vehicle, and data regarding the tailpipe emissions from the vehicle. Any of these three detection systems may be incorporated in as the host unit 10. In the illustrated embodiment, the emissions sensor is incorporated with the host unit 10 in a common housing. In alternative embodiments, a system may be configured that only senses the speed of the vehicle and records a picture of the vehicle, without sensing emissions. In such embodiments, the host unit 10 can be a separate unit or can be incorporated with the unit that senses speed and acceleration. In other embodiments, the host unit 10 might sense other vehicle data. Thus, although the host unit 10 is illustrated in FIG. 1 as containing the emissions detection unit as well, the host unit 10 could alternatively be incorporated with the speed and acceleration unit 12, or the camera unit 22.

In a preferred embodiment, the host unit 10 receives the data into a central processing unit 26, which may be an EBX platform computer, using a PC 104 or PC104 +bus structure. This arrangement provides a desirable degree of compactness. However, any suitable CPU unit may be used.

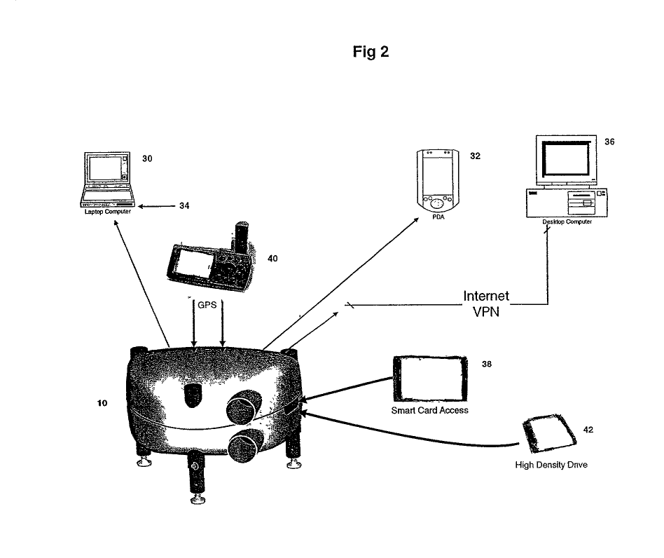

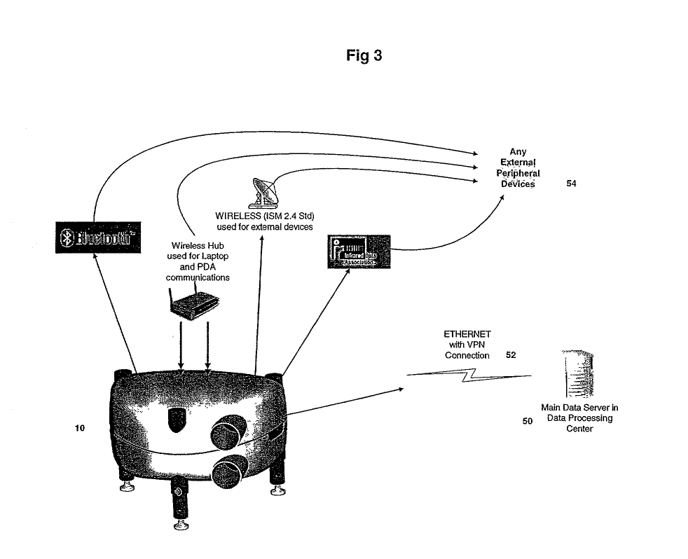

FIG. 2 is a schematic view depicting a host and various data input and output devices, and other devices which may be utilized in preferred embodiments of the invention. FIG. 3 is a schematic view depicting several modes of communication that may utilized between a host and various other devices in preferred embodiments of the invention.

As described in more detail herein, and as shown in FIG. 2, a wide variety of methods can be used (1) to input sensed data to the central processing unit 26; (2) to input instructions to the central processing unit 26, and (3) to retrieve vehicle-related and other data that has been stored by the central processing unit 26. Any or all of these three functions can be achieved by using any or all of the various peripheral communication equipment described. For example, as illustrated in FIG. 2, it is possible for an operator to visit the site and utilize a laptop computer 30 and/or a Personal Digital Assistant (“PDA”) 32 to perform these functions on the host 10. For example, an operator may use a PDA 32 or a laptop computer 30 to input instructions to the host 10. The laptop computer 30 and/or PDA 32 can also be used to display various information from the host 10, such as present operational settings. This provides an advantage of the invention, whereby there is no need to provide a display or input keyboard on the host unit 10 itself. These devices can be linked into the host 10 either through an Ethernet connection, or through the preferred embodiment of a wireless connection. A wireless connection provides greater flexibility for the operator in checking the operational status of the system.

If the memory of the laptop 30 or PDA 32 is adequate, the vehicle data records obtained from a sensing session may be transferred into the laptop 30 and/or PDA 32 and then physically carried to a central processing station where the data is downloaded and processed.

In one preferred embodiment, the data can be downloaded onto a high density storage drive system 34 associated with the laptop computer 30. Alternatively, the high density drive system 42 could be incorporated in the host unit 10, with a removable memory element that is connected to the host 10 via an Integrated Drive Electronics (IDE), Small Computer System Interface (SCSI), PC Card Type II adapter or Universal Serial Bus (USB) connection, then removed by the user to be taken to a central processing facility. In a preferred embodiment, the drive 42 is a compactflash CF+ Type II hard drive (e.g., IBM Microdrive TM).

In addition to, or as an alternative to, the use of a laptop 30 or a PDA 32, the host 10 on the laptop 30 or PDA 32 may be connected through the Internet via a Virtual Private Network (“VPN”) to a desktop computer 36 using a client/server relationship. The desktop computer 36 may be located in the remote central data processing facility, or may be located at an intermediate location or even at the sensing site, or near the host 10.

In a preferred embodiment, “smart card” technology is used to enhance the security of the system. The host unit 10 may include a slot for reading a smart card 38. Each of the other peripherals such as the laptop computer 30, PDA 32 and/or the desktop computer 36 may also each have a smart card reader.

The security levels by using different smart cards can be segregated by “per user” and “per function” type of security. Smart cards can be programmed with levels of security for different types of users such as for example, Auditor, Field Technician, Repair Technician, Engineer, and other types of users and security levels commensurate with such users. Users can be permitted to or prevented from accessing certain features and functions of the host unit 10 and associated commands and stored data. The same is true for devices that may attempt a function that the device cannot support or should be prevented from even initiating a function. Given the programmable flexibility of a smart card, per user validation can be set to expire, master site list can be periodically updated, and simple applets can be added, updated, and removed per individual network requirements.

An additional feature of the preferred embodiment is that the host unit 10 can communicate with, or incorporate a global positioning system (“GPS”) receiver unit 40. One benefit of communicating with a GPS unit 40 is that the host unit 10 can record its location from many satellites orbiting the earth so that data records taken at that location will include a precise identification of the location. In addition, the GPS unit 40 provides date and time information via the GPS system. Accordingly, when a user first sets up the host 10 at a location, the user can use the GPS unit 40 to provide location, date, and time information. The GPS unit 40 may be a separate handheld device carried by the user, or in a preferred embodiment, be provided by appropriate circuitry permanently installed into the host unit 10. The smart card may also hold a master list of locations with coordinates for the locations of where the host may be located, in order to compare GPS unit 40 data against expected coordinates providing an added measure of quality control.

FIG. 3 illustrates various modes of communication by which the host 10 may communicate with the various peripheral devices of FIG. 2, and ultimately with a central processing facility 50. One way for such communication is for the host unit 10 to be connected directly with the central processing unit 50 via a Virtual Private Network 52 over the Internet.

In one embodiment, where the host unit 10 is to be installed permanently or semi-permanently, the host until 10 will be connected either with wires or wirelessly to the existing Internet infrastructure and in this way communicates with the central facility 50.

In addition, the host unit can send information and receive information using any of the “Blue Tooth” standard, jump-scanned wireless RF frequencies, and/or infrared (“IRDA”) communications. The above communications may be received by a device 54, which may be any of the peripherals 30, 32, and 36 described herein, or some other receiving/sending device that is in communication with the host 10 such as a speed & acceleration sensor 12 via antenna 20, or camera 14 via antenna 22.

In a preferred embodiment, the host system 10 records a log of individual vehicle entries including sensed data. The log may also include user input information and other information about the circumstances surrounding each captured entry. The user can append the log with such information via any of the external devices 30, 32, and 36 described above. The host 10 can then record this user input information in a log that may also include specific vehicle entries. In addition, the log can contain date and time of recurrent events and activities conducted by the host, and contain exception and problem events. Lastly, the log can contain date and time of when a user logged into and out of the host. All of this information is useful in the validation of the data collected by the host.

Further, in some embodiments the host 10 also has the ability to verify information (for example, where the host 10 has a internal GPS unit 40 that provides the date and time). In those embodiments the host 10 can validate the date and time of a peripheral device 30,32, and 36 to ensure accuracy. That is, the host will synchronize, or reset, the internal time of a peripheral device 30,32, and 36 with date and time information provided by GPS unit 40 in the host 10.

As described herein, the embodiments of the present invention can provide an integral host unit that is self-contained during vehicle data sensing sessions and does not require a van or operator to be present during data capture. The invention also provides embodiments that provide secure and convenient retrieval of data and control of the unit.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A system for processing sensed vehicle data, comprising:
a sensor for sensing data related to at least one characteristic of a passing vehicle; and
a host unit that receives sensed data from the sensor.

2. A system according to claim 1, wherein the sensor and the host unit are integrated into a single housing.

3. A system according to claim 1 wherein the sensor is a vehicle emissions sensor.

4. A system according to claim 1, wherein the sensor is a vehicle speed sensor.

5. A system according to claim 1, wherein the sensor is a camera.

6. A system according to claim 1, wherein the system updates an internal events log.

7. A system according to claim 1, further comprising a peripheral communication device, wherein the peripheral communication device and the host unit communicate with each other to transfer at least one of sensed vehicle data and commands between the host unit and the peripheral communication device.

8. A system according to claim 7, wherein the host includes a memory for storing sensed vehicle data.

9. A system according to claim 7, wherein the peripheral communication device is a laptop computer.

10. A system according to claim 7, wherein the peripheral communication device is a Personal Digital Assistant.

11. A system according to claim 7, wherein the peripheral communication device is a desktop computer.

12. A system according to claim 7, wherein peripheral communication devices are date and time synchronized to the host unit's date and time.

13. A system according to claim 1, wherein the host comprises a smart card reader.

14. A system according to claim 7 wherein the peripheral communication device comprises a smart card reader.

15. A system according to claim 7, wherein the peripheral communication device transfers data to a central processing facility.

16. A system according to claim 1, wherein the host communicates with the peripheral communication device via an infrared signal.

17. A system according to claim 1, wherein the host communicates with the peripheral communication device using an internet connection.

18. A system according to claim 1, wherein the host communicates with the peripheral communication device using wireless RF frequency.

19. A system according to claim 1, wherein the host communicates with the peripheral device via the Blue Tooth™ standard.

20. A system according to claim 1, wherein the host communicates with the peripheral device using a Virtual Private Network over the Internet.

21 A system according to claim 1, wherein the host transfers data to central processing facility.

22. A system according to claim 21, wherein in the host communicates with the central processing facility using a Virtual Private Network over the Internet.

23. A system according to claim 1, wherein the host includes a removable nonvolatile memory media and stores sensed vehicle data on the removable nonvolatile memory media.

24. A system for processing sensed vehicle data, comprising:
means for sensing data related to at least one characteristic of a passing vehicle; and
means for receiving sensed data from the sensor and storing said sensed data, wherein the sensor and host are integrated into a single housing.

25. A method for processing sensed vehicle data, comprising the steps of:
sensing data related to at least one characteristic of a passing vehicle;
receiving and storing the sensed data with a host unit that is integrated into a single housing together with the sensor; and
appending events into an electronic log that includes a date and time stamp of when an event occurred.

26. A method according to claim 25, further comprising the step of communicating between the host and a peripheral device, wherein the peripheral device comprises at least one of a laptop computer, a Personal Digital Assistant, and a desktop computer.
